(19) United States
(12) Patent Application Publication
(10) Pub. No.: US 2026/0195810 A1
(43) Pub. Date: Jul. 9, 2026

(54) SYSTEMS AND METHODS FOR PROVIDING UNIFIED ACCESS TO BENEFITS FOR FINANCIAL ACCOUNTS

(71) Applicant: JPMORGAN CHASE BANK, N.A., New York, NY (US)

(72) Inventors: Nishith ROUT, Kennett Square, PA (US); Pradeep GANGABHATHINA, Frisco, TX (US); Sudharsan SELVAKUMAR, Irving, TX (US); Rasik GOYAL, Newark, DE (US); Ashwath Suresh KUMAR, Middletown, DE (US); Selva DHARMARAJ, Wilmington, DE (US); Sujan BOLAR, Allen, TX (US)

(21) Appl. No.: 19/012,566

(22) Filed: Jan. 7, 2025

(51) Int. Cl. G06Q 40/03; G06Q 30/0207

(52) U.S. Cl. CPC G06Q 40/03; G06Q 30/0215

(57) ABSTRACT

Systems and methods for providing unified access to benefits for financial accounts are disclosed. In one embodiment, a method may include: (1) retrieving, by a benefits computer program executed by an electronic device, an identification of an active credit card issued to a cardholder; (2) retrieving, by the benefits computer program, card benefits for the active credit card from a card benefits database; (3) retrieving, by the benefits computer program, cardholder benefit information for the cardholder; (4) calculating, by the benefits computer program, a benefits value score based on the cardholder benefit information, wherein the benefits value score comprises a list of the card benefits for the active card, a value of each of the card benefits, and an enrollment status for each of the card benefits; and (5) displaying, by the benefits computer program, the benefits value score on an electronic device.

### BACKGROUND OF THE INVENTION

### 1. Field of the Invention

Embodiments relate to systems and methods for providing unified access to benefits for financial accounts.

### 2. Description of the Related Art

Credit card issuers provide their customers with a number of benefits. Customers, however, often are unaware of these benefits. Even if the customers are aware of the benefits, it is difficult to educate them on the monetary value of the benefits that their credit cards provide.

### SUMMARY OF THE INVENTION

Systems and methods for providing unified access to benefits for financial accounts are disclosed. In one embodiment, a method may include: (1) retrieving, by a benefits computer program executed by an electronic device, an identification of an active credit card issued to a cardholder; (2) retrieving, by the benefits computer program, card benefits for the active credit card from a card benefits database; (3) retrieving, by the benefits computer program, cardholder benefit information for the cardholder; (4) calculating, by the benefits computer program, a benefits value score based on the cardholder benefit information, wherein the benefits value score comprises a list of the card benefits for the active card, a value of each of the card benefits, and an enrollment status for each of the card benefits; and (5) displaying, by the benefits computer program, the benefits value score on an electronic device.

In one embodiment, the step of retrieving, by the benefits computer program, cardholder benefit information for the cardholder comprises: retrieving, by the benefits computer program, card benefits provided by an issuer of the active credit card; and retrieving, by the benefits computer program, card benefits provided by a third-party partner of the issuer.

In one embodiment, the card benefits provided by the issuer comprise discounts, purchase protection, extended protection, price protection, return protection travel protection and, rental car insurance.

In one embodiment, the card benefits provided by the third-party partner comprise a third-party discount on a good or service provided by the third-party partner.

In one embodiment, the cardholder benefit information comprises reward points earned by the cardholder and information on card benefits used by the cardholder.

In one embodiment, the method may also include: displaying, by the benefits computer program, a link to enroll in any unenrolled card benefits.

In one embodiment, the value of each of the card benefits is calculated by applying a rule.

In one embodiment, the benefits value score is based on a period of time.

In one embodiment, the method may also include: reviewing, by the benefits computer program, past transactions for the cardholder; identifying, by the benefits computer program, one of the past transactions with a merchant that is ineligible for one of the card benefits; identifying, by the benefits computer program, an alternate merchant with which the past transaction would have been eligible for the one of the card benefits; and suggesting, by the benefits computer program and with the benefits value score, that the cardholder use the alternate merchant.

According to another embodiment, a method may include: (1) receiving, by a computer program executed by a financial institution backend and from a third-party computer application for a third-party executed by a cardholder electronic device, a primary account number for a cardholder and a request for eligibility to enroll in a third-party card benefit offered by the third-party and managed by the financial institution backend; (2) determining, by the computer program, that the primary account number is eligible for the third-party card benefit offered by the third-party; (3) generating, by the computer program, an account token for the primary account number and a cardholder identifier; (4) returning, by the computer program, the account token to the third-party computer application; (5) receiving, by the computer program and from the third-party computer application, an enrollment request to enroll in the third-party card benefit; and (6) enrolling, by the computer program, the account token for the third-party card benefit.

In one embodiment, the method may also include: receiving, by the computer program, benefit credit information from the third-party computer application; and validating, by the computer program, the enrolled third-party card benefit using the benefit credit information.

In one embodiment, the method may also include: determining, by the computer program, that the third-party card benefit was under-awarded or over-awarded; and executing, by the computer program, a corrective action to correct the enrollment or to correct the benefit credit information.

In one embodiment, the corrective action enrolls or disenrolls the primary account number from the third-party card benefit.

In one embodiment, the benefit credit information comprises a statement credit, a promotional credit, and/or an applied discount.

According to another embodiment, a non-transitory computer readable storage medium, may include instructions stored thereon, which when read and executed by one or more computer processors, cause the one or more computer processors to perform steps comprising: receiving, from a third-party computer application for a third-party executed by a cardholder electronic device, a primary account number for a cardholder and a request for eligibility to enroll in a third-party card benefit offered by the third-party and managed by a financial institution backend; determining that the primary account number is eligible for the third-party card benefit offered by the third-party; generating an account token for the primary account number and a cardholder identifier; returning the account token to the third-party computer application; receiving, from the third-party computer application, an enrollment request to enroll in the third-party card benefit; and enrolling the account token for the third-party card benefit.

In one embodiment, the non-transitory computer readable storage medium may also include instructions stored thereon, which when read and executed by the one or more computer processors, cause the one or more computer processors to perform steps comprising: receiving benefit credit information from the third-party computer application; and validating the enrolled third-party card benefit using the benefit credit information.

In one embodiment, the non-transitory computer readable storage medium may also include instructions stored thereon, which when read and executed by the one or more computer processors, cause the one or more computer processors to perform steps comprising: determining that the third-party card benefit was under-awarded or over-awarded; and executing a corrective action to correct the enrollment or to correct the benefit credit information.

In one embodiment, the corrective action enrolls or disenrolls the primary account number from the third-party card benefit.

In one embodiment, the benefit credit information comprises a statement credit, a promotional credit, and/or an applied discount.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for providing unified access to benefits for financial accounts according to an embodiment;

FIG. 2 depicts a method for providing unified access to benefits for financial accounts according to an embodiment;

FIG. 3 depicts a method for enrolling benefits with a third-party using 3-Legged authentication according to an embodiment;

FIG. 4 depicts a method for a determining benefits eligibility by a third-party according to an embodiment; and

FIG. 5 depicts an exemplary computing system for implementing aspects of the present disclosure.

### DETAILED DESCRIPTION OF PREFERRED EMBODIMENTS

Embodiments relate to systems and methods for providing unified access to benefits for financial accounts.

In an embodiment, a three-stage architectural pattern may be used. First, the benefits data may be standardized. For example, benefits may be managed in a benefits catalog, which provides a single point of access to all benefits across all systems of record within a financial institution. A standardized integration model (e.g., a common API and data exchange mechanism for different benefits and partners) may be provided that enables onboarding of new partners, increases flexibility for partner offerings, and delivers robust systematic auditing and controls to ensure benefits are fulfilled accurately. It may also provide a suite of solution options to meet specific partner needs (e.g., API 2-legged, API 3-legged, webhook, batch files, etc.).

The next stage is validation. Embodiments may systemically validate fulfillment benefit, flag accounts for under-providing and over-providing, and report flagged data to business to drive manual remediation efforts. This may further include processing and aggregating various benefit data points to get a consolidated view of the total benefit amount per customer, and implementing a personalized benefit list to the customer based on usage and customer intent.

Next, embodiments may provide a customer experience that provides a “score card” of sorts that provides a monetized value of used and un-used benefits. For example, embodiments may display a personalized, un-used benefit message to the customer based on customer intent and recent activity. Embodiments may streamline customer enrollment experience for partner and non-partner benefits by implementing 3-legged oath with partners.

Examples of benefits include discounts, purchase protection (e.g., a benefit that will repair, replace, or reimburse for eligible items that are lost, stolen, or damaged), extended protection (e.g., extending the period of the manufacturer's written warranty), price protection (e.g., refunding the difference between the purchase price and an advertised price for an item), return protection (e.g., reimbursing for the cost of an item if the merchant will not accept a return), personal identity theft protection (e.g., reimbursing for covered expenses in relation to a stolen identity event), travel protection (e.g., providing insurance for travel-related delays and issues), rental car insurance (e.g., automatically provides rental car insurance at no additional cost), roadside assistance, third-party discounts on a good or service provided by the third-party partner (e.g., free or discounted membership, free or discounted delivery, etc.), and others.

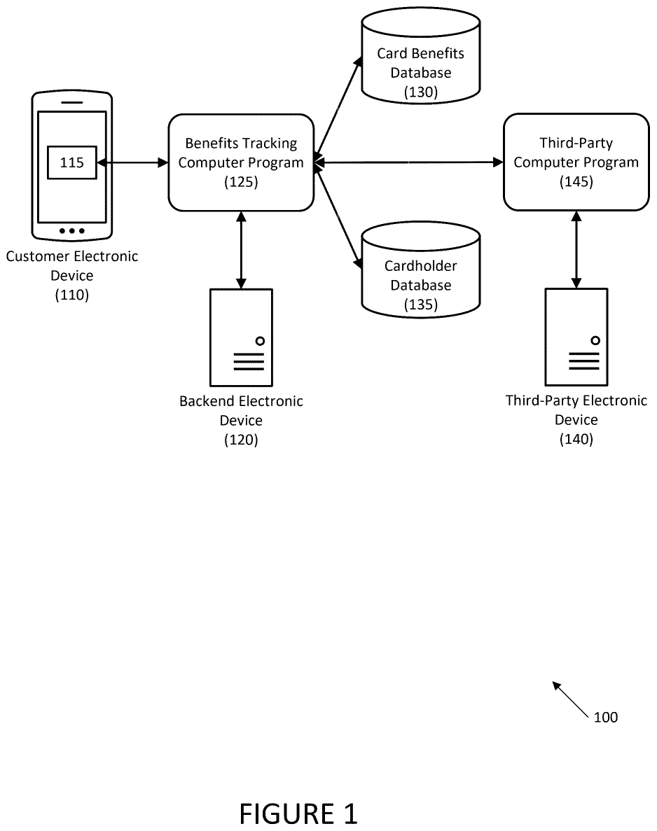

Referring to FIG. 1, a system for providing unified access to benefits for financial accounts is disclosed according to an embodiment. System 100 may include customer electronic device 110, which may be a computer (e.g., workstation, desktop, laptop, notebook, tablet, etc.), a smart device (e.g., smartphone, smart watch, etc.), and Internet of Thing (IoT) appliance, etc. Customer electronic device 110 may execute customer computer program 115, which may be an application, a browser, etc.

Customer computer program 115 may interface with benefits tracking computer program 125, which may be executed by backend electronic device 120, such as a server (e.g., physical and/or cloud-based), a computer, etc.

Benefits tracking computer program 125 may retrieve data from databases, such as card benefits database 130 and cardholder database 135. Card benefits database 130 may store information on benefits that are available to credit cards, debit cards, etc., including enrollment requirements for the benefits (e.g., automatically enrolled, need to enroll, etc.).

Cardholder database 135 may include data for the different cardholders, including issued cards, cardholder benefits details (e.g., enrollment, benefits used, accumulated benefits, etc.).

Benefits tracking computer program 125 may further interface with third-party computer program 145 that may be executed by third-party electronic device 140. In one embodiment, the third-party may be a partner of the financial institution issuing the credit card, debit card, etc.

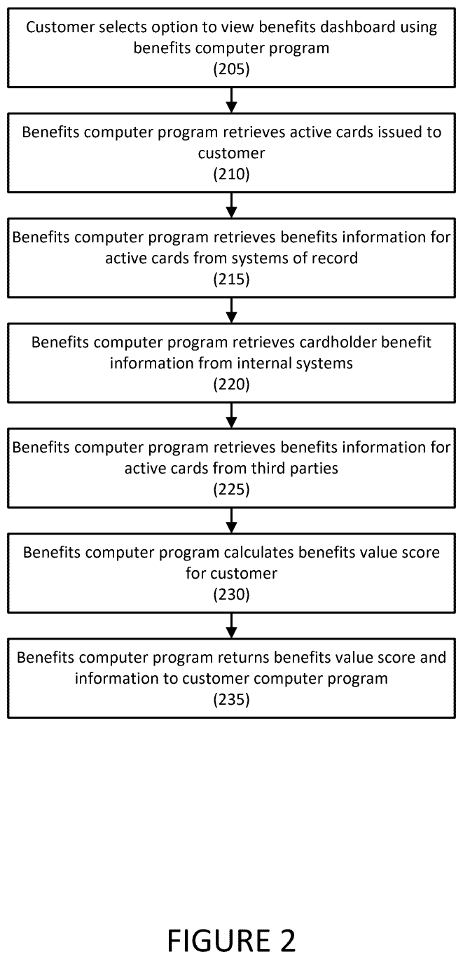

Referring to FIG. 2, a method for providing unified access to benefits for financial accounts is disclosed according to an embodiment.

In step 205, using a customer computer program executed by customer electronic device, such as a computer, a smart device, etc., a customer may select an option to view a benefits dashboard for benefits that a credit card, a debit card, etc. that they have been issued is eligible for. The customer computer program may be an application or a browser that may interface with a card benefits computer program that may be executed by a backend electronic device for the card issuer.

In one embodiment, the customer may be authenticated before viewing the benefits dashboard. For example, the customer may be authenticated by providing a username and password, biometric authentication, out-of-band authentication, etc.

In step 210, the benefits computer program may retrieve an identification of the active cards that have been issued to the customer. In one embodiment, the benefits computer program may retrieve the identification of the active cards from a cache; in another embodiment, the benefits computer program may contact a card issuer system with a customer identifier to retrieve the active cards.

In step 215, the benefits computer program may access a database of card benefits and may retrieve the benefits for the customer's active cards. In one embodiment, the database may store a catalog of types of cards and the benefits available to each type of card. The database may also store information on which benefits the customer is automatically enrolled in, which benefits the customer must enroll in before they are active, etc.

In step 220, the benefits computer program may retrieve cardholder benefit information for the cardholder from internal systems, including the benefits that the cardholder has enrolled in, the cardholder's reward points or other benefits status, any statement credits (used and unused), etc. It may further retrieve information on benefits that the cardholder has used and/or benefits that the cardholder has not used.

In step 225, the benefits computer program may retrieve benefits information for the cardholder's active cards from third parties, such as active discounts, passes, etc. that third parties may offer cardholders of the active cards. This may include the monetary value of benefits provided to the customer by the third parties.

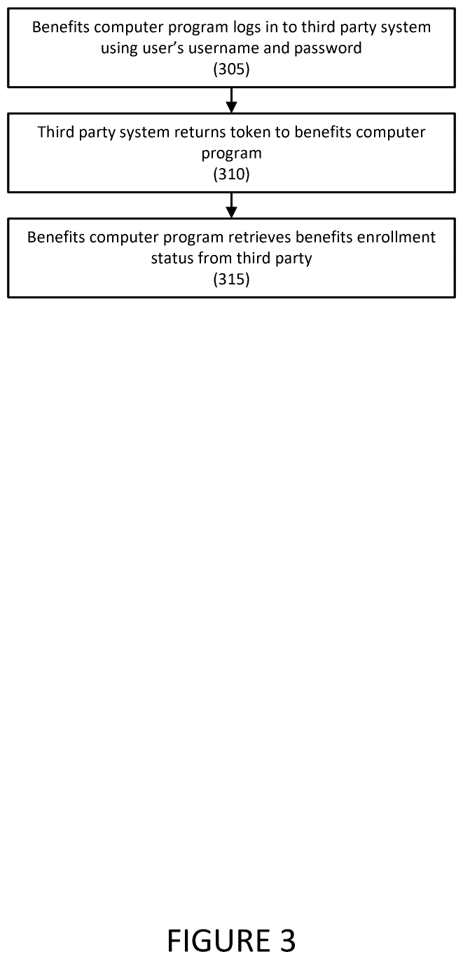

An exemplary method for doing so is disclosed in FIG. 3.

Referring to FIG. 3, a method for enrolling benefits with a third-party using 3-Legged authentication is provided according to an embodiment.

In step 305, the benefits computer program may login to a third-party system using the user's username and password for the third-party. For example, in one embodiment, the user may provide the user's login information for the third-party system to the benefits computer program.

In step 310, the benefits computer program may receive a token from the third-party system after the username and password is validated. In one embodiment, the token may be an oAUTH token.

In step 315, the benefits computer program may retrieve the user's benefits enrollment status from third-party using the token.

In one embodiment, whenever there are changes about the user's enrollment status, the third-party may call the benefits computer program using an API.

Referring again to FIG. 2, in step 230, using the retrieved information, the benefits computer program may calculate a benefits value score for the customer. The benefits value score may provide a list of benefits that the active cards are eligible for, an enrollment status for each benefit (if applicable), a total value of each benefit, a used value to date for each benefit, an unused benefit balance, etc. In one embodiment, for any unenrolled benefits, the customer may be presented with a link to enroll in the benefit.

In one embodiment, the benefits computer program may apply business rules to calculate a benefits value score for a period, such as an anniversary period using the data from the internal and external third-party systems and by applying pre-defined rules.

In one embodiment, the benefits value dashboard may provide a total value of all benefits for each active card, as well as a value for the benefits that have been used to date.

In one embodiment, the rules may also identify any card benefits that the cardholder may be missing out on. For example, the cardholder may use a food delivery service that does not provide benefits to cardholders. Using machine learning, the benefits computer program may identify such transactions and may suggest to the cardholder that the cardholder use a food delivery service that does provide card benefits, such as discounted delivery, free membership, etc.

In step 235, the benefits computer program may return the benefits value score and any other information to the customer computer program, which may display the benefits value score and the information to the customer. The benefits computer program may also display a value of used benefits and unused benefits for the period.

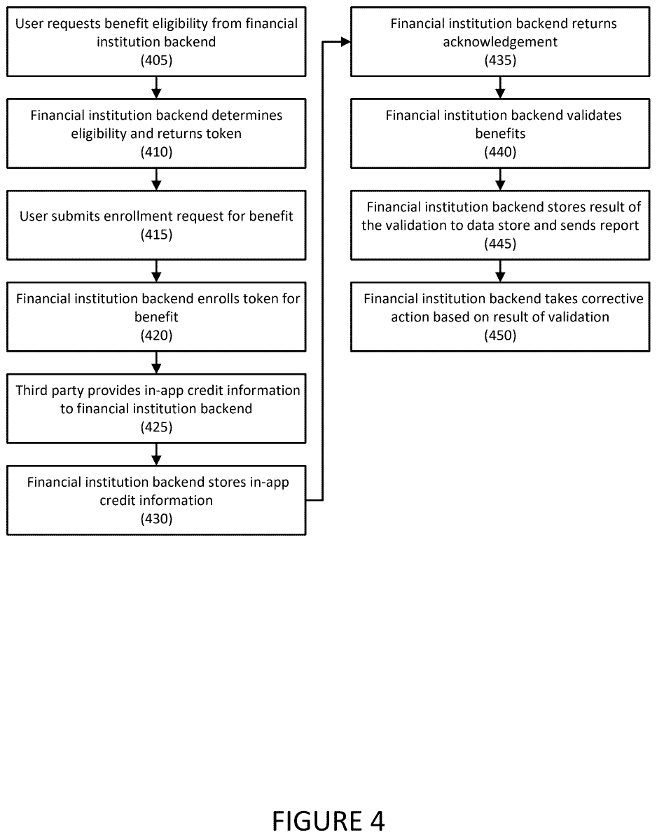

Referring to FIG. 4, a method for a determining benefits eligibility by a third-party is provided according to an embodiment FIG. 4 depicts an exemplary computing system for implementing aspects of the present disclosure.

In step 405, using a third-party mobile application or computer program, a cardholder may provide the cardholder's primary account number to the financial institution backend with a request for a benefit eligibility (e.g., free shipping, discounts, etc.) that is offered by a third party, such as a partner of the financial institution and managed by the financial institution backend.

In step 410, the financial institution backend may determine eligibility for the primary account number, and may return an eligibility flag and an account token in response to the primary account number being eligible for the benefit.

In step 415, using the third-party mobile application or computer program, the cardholder may submit an enrollment request to enroll in the benefit. The request may include, for example, the account token and the cardholder's member identifier with the third-party.

In step 420, the financial institution backend may enroll the account token in the benefit, and may return a response, including an expiration date for the benefit.

In step 425, the third-party mobile application or computer program may return benefit credit information, such as in-app credit information, to the financial institution backend. In-app credit information may include credit fulfilled by the third-party in its system, such as a statement credit, a promotional credit, applied discounts, etc.

In step 430, the financial institution backend may store the benefit credit information in a data store.

In step 435, the financial institution backend may return an acknowledgement to the third-party mobile application or computer program.

In step 440, in response to a validation request, the financial institution backend may validate any benefits that were under-awarded or over-awarded. An example of an under-awarded benefit is when a customer has not received the full value of a benefit (e.g., the benefit value is $100, but the customer receives $80 based on the third-party data). An example of an over-awarded benefit is when a customer received more than the value of the benefit (e.g., the customer's subscription expired in the financial institution backend, but the customer continues to receive the benefit from the third-party). A rules engine may be used to perform the validation.

For example, after receiving benefit enrollment and/or credit information from the third parties, the financial institution backend computer program may compare the data received with its local data and may determine if the third parties fulfilled the enrolled benefits as configured for each customer account in question for a time duration.

In step 445, the financial institution backend may provide the result of the validation to the data store and may send a report to a data lake.

In step 450, based on the results of the validation, the financial institution backend may take one or more automated actions. For example, in response to the validation identifying an exception, such as under-awarded or over-awarded benefits, the backend computer program may trigger a corrective action with the third party to fix enrollments, fix credits, etc. The backend computer program may post the fix and update the third-party to close the exception.

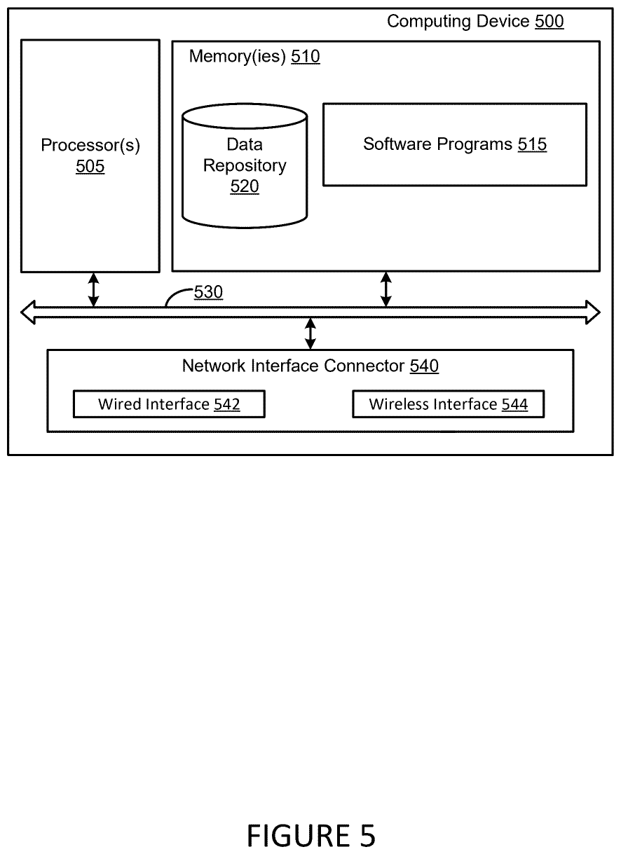

FIG. 5 depicts exemplary computing device 500. Computing device 500 may represent the system components described herein. Computing device 500 may include processor 505 that may be coupled to memory 510. Memory 510 may include volatile memory. Processor 505 may execute computer-executable program code stored in memory 510, such as software programs 515. Software programs 515 may include one or more of the logical steps disclosed herein as a programmatic instruction, which may be executed by processor 505. Memory 510 may also include data repository 520, which may be nonvolatile memory for data persistence. Processor 505 and memory 510 may be coupled by bus 530. Bus 530 may also be coupled to one or more network interface connectors 540, such as wired network interface 542 or wireless network interface 544. Computing device 500 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

1. A method, comprising:
retrieving, by a benefits tracking computer program executed by a backend electronic device, an identification of an active credit card issued to a cardholder;
retrieving, by the benefits tracking computer program, card benefits for the active credit card from a card benefits database;
retrieving, by the benefits tracking computer program, cardholder benefit information for the cardholder, wherein the cardholder benefit information comprises the card benefits used by the cardholder and the card benefits not used by the cardholder;
calculating, by the benefits tracking computer program, a benefits value score based on the cardholder benefit information, wherein the benefits value score comprises a list of the card benefits for the active card, a value of each of the card benefits, and an enrollment status for each of the card benefits; and
displaying, by the benefits tracking computer program, the benefits value score on a customer electronic device.

2. The method of claim 1, wherein the step of retrieving, by the benefits tracking computer program, cardholder benefit information for the cardholder comprises:
retrieving, by the benefits tracking computer program, card benefits provided by an issuer of the active credit card; and
retrieving, by the benefits tracking computer program, card benefits provided by a third-party partner of the issuer.

3. The method of claim 2, wherein the card benefits provided by the issuer comprise discounts, purchase protection, extended protection, price protection, return protection, travel protection and, rental car insurance.

4. The method of claim 2, wherein the card benefits provided by the third-party partner comprise a third-party discount on a good or service provided by the third-party partner.

5. The method of claim 1, wherein the cardholder benefit information comprises reward points earned by the cardholder and information on card benefits used by the cardholder.

6. The method of claim 1, further comprising:
displaying, by the benefits tracking computer program, a link on the customer electronic device to enroll in any unenrolled card benefits.

7. The method of claim 1, wherein the value of each of the card benefits is calculated by applying a rule.

8. The method of claim 1, wherein the benefits value score is based on a period of time.

9. The method of claim 1, further comprising:
reviewing, by the benefits tracking computer program, past transactions for the cardholder;
identifying, by the benefits tracking computer program, one of the past transactions with a merchant that is ineligible for one of the card benefits;
identifying, by the benefits tracking computer program, an alternate merchant with which the past transaction would have been eligible for the one of the card benefits; and
suggesting, by the benefits tracking computer program and with the benefits value score, that the cardholder use the alternate merchant.

10. A method, comprising:
receiving, by a computer program executed by a financial institution backend and from a third-party computer application for a third-party executed by a cardholder electronic device, a primary account number for a cardholder and a request for eligibility to enroll in a third-party card benefit offered by the third-party and managed by the financial institution backend;
determining, by the computer program, that the primary account number is eligible for the third-party card benefit offered by the third-party;
generating, by the computer program, an account token for the primary account number and a cardholder identifier;
returning, by the computer program, the account token to the third-party computer application;
receiving, by the computer program and from the third-party computer application, an enrollment request to enroll in the third-party card benefit; and
enrolling, by the computer program, the account token for the third-party card benefit.

11. The method of claim 10, further comprising:
receiving, by the computer program, benefit credit information from the third-party computer application; and
validating, by the computer program, the enrolled third-party card benefit using the benefit credit information.

12. The method of claim 11, further comprising:
determining, by the computer program, that the third-party card benefit was under-awarded or over-awarded; and
executing, by the computer program, a corrective action to correct the enrollment or to correct the benefit credit information.

13. The method of claim 12, wherein the corrective action enrolls or disenrolls the primary account number from the third-party card benefit.

14. The method of claim 12, wherein the benefit credit information comprises a statement credit, a promotional credit, and/or an applied discount.

15. A non-transitory computer readable storage medium, including instructions stored thereon, which when read and executed by one or more computer processors, cause the one or more computer processors to perform steps comprising:
receiving, from a third-party computer application for a third-party executed by a cardholder electronic device, a primary account number for a cardholder and a request for eligibility to enroll in a third-party card benefit offered by the third-party and managed by a financial institution backend;
determining that the primary account number is eligible for the third-party card benefit offered by the third-party;
generating an account token for the primary account number and a cardholder identifier;
returning the account token to the third-party computer application;
receiving, from the third-party computer application, an enrollment request to enroll in the third-party card benefit; and
enrolling the account token for the third-party card benefit.

16. The non-transitory computer readable storage medium of claim 15, further including instructions stored thereon, which when read and executed by the one or more computer processors, cause the one or more computer processors to perform steps comprising:
receiving benefit credit information from the third-party computer application; and
validating the enrolled third-party card benefit using the benefit credit information.

17. The non-transitory computer readable storage medium of claim 16, further including instructions stored thereon, which when read and executed by the one or more computer processors, cause the one or more computer processors to perform steps comprising:
determining that the third-party card benefit was under-awarded or over-awarded; and
executing a corrective action to correct the enrollment or to correct the benefit credit information.

18. The non-transitory computer readable storage medium of claim 17, wherein the corrective action enrolls or disenrolls the primary account number from the third-party card benefit.

19. The non-transitory computer readable storage medium of claim 17, wherein the benefit credit information comprises a statement credit, a promotional credit, and/or an applied discount.
